(19) United States
(12) Patent Application Publication
(10) Pub. No.: US 2012/0028614 A1
(43) Pub. Date: Feb. 2, 2012

(54) METHOD AND SYSTEM FOR PROCESSING UNIFIED STATE CHANGE NOTIFICATIONS

(76) Inventors: Olivier J. Bertin, Peymeinade (FR); Martin Schluetter, Bocholt (DE)

(21) Appl. No.: 12/847,066

(22) Filed: Jul. 30, 2010

(51) Int. Cl. H04M 11/00; H04W 4/12; H04W 68/00; G06F 15/173

(52) U.S. Cl. 455/412.2; 709/224; 379/88.13

(57) ABSTRACT

An embodiment of the present invention provides a computer system for processing state change notifications. The system includes at least one state server configured to generate a state change notification to be delivered to a terminal. The system also includes a State Composition and Notification server operatively coupled to the at least one state server and configured to receive one or more state change notifications from the at least one state server, generate a unified state change notification based on the one or more state change notifications received from the at least one state server, and send the unified state change notification to the terminal.

### BACKGROUND

Modern communication networks allow devices and users to subscribe to states of other devices and users as well as states corresponding to the user's own device. The state corresponds to an event that is applicable to one or more users or devices in the network. For example, in a mobile phone network, a message-waiting state can inform the user of a mobile phone that he or she has received a message that is waiting to be retrieved, for example, a text message, or voicemail message. In a telecommunications network, various types of call states can be used to indicate the status of an initiated phone call, for example, whether a device to which a phone call is directed is ringing or busy. In various types of networks, such as a social networking website, a presence state may be used to indicate a user's willingness or ability to receive communications from other users in the network.

Users and devices can subscribe to the states of other users and devices in order to be informed of various state changes, such as a registration state change, a presence state change, a call state change, a message waiting indication, and other sorts of state changes. For example, a device can subscribe to a User Agent Profile (UAProf) Delivery Server in order to be notified of new device profile (configuration) available to retrieve from the server and apply on the device. A user may also subscribe to his or her own state, for example, to receive a message waiting notification.

Typical network protocols used to support state subscriptions are the Session Initiation Protocol (SIP) and Web Services Notifications (WSN) protocols. Any given device can be subscribed to several states, resulting in large number of subscriptions that can generate large amounts of network traffic. In some cases, the network traffic supporting the state subscriptions may exceed the capabilities of the network and/or the devices coupled to the Network.

### BRIEF DESCRIPTION OF THE DRAWINGS

Certain exemplary embodiments are described in the following detailed description and in reference to the drawings, in which:

FIG. 1 is a diagram of a communications network, in accordance with an embodiment of the present invention;

FIG. 2 is a block diagram of a method of processing state notification information, in accordance with embodiments of the present invention; and

FIG. 3 is a is a block diagram showing a non-transitory, computer-readable medium that stores code configured to process state notification information, in accordance with an exemplary embodiment of the present invention.

### DETAILED DESCRIPTION OF SPECIFIC EMBODIMENTS

An embodiment of the present invention provides a system for managing state change notifications in a communications network. Typically, each of the states that a user subscribes to uses a specific subscription from the user's terminal to a specific State Notification Server (Presence Server, Call State Server, Profile Server, etc.). In such cases, each subscription uses a separate communication from the user terminal to the specific State Notification Server. In embodiments of the present invention, a system is provided wherein a user or device subscribes to a single, unified state subscription and receives state change notifications of various types corresponding to the various notifications that the user or device is configured to receive. The unified state subscription may be managed by a single server, referred to herein as a “State Composition and Notification Server.” The State Composition and Notification Server may encode state change notifications using a common data format that applies to all of the state change notifications sent to the user or device.

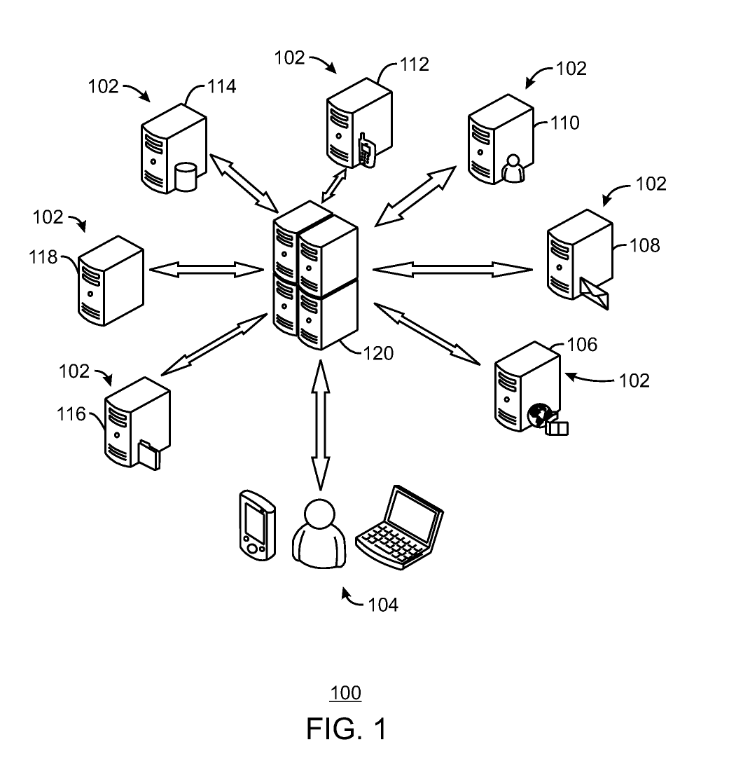

FIG. 1 is a diagram of a communications network, in accordance with an embodiment of the present invention. The communications network is generally referred to by the reference number 100 and may include a telecommunications network, mobile phone network, and the like. The communications network 100 may also include a network of personal computers coupled through the Internet. As shown in FIG. 1, the communications network 100 may include one or more state servers 102 that provide various notification and information services to a user at a terminal 104. The terminal 104 may be any electronic communications device associated with a user, including portable or handheld devices. For example, the terminal 104 may be a mobile phone, portable media device, laptop computer, desktop computer, and the like.

In an embodiment, the terminal 104 may be dedicated to a single user, as in the case of a mobile phone. The state change notifications sent to the terminal 104 may be directed to a known user of the dedicated terminal. In an embodiment, the terminal 104 may be associated with several users, as in the case of a desktop computer. If the terminal 104 is associated with several users, the identity of the user may be verified, for example, through the use of a password, before state change notifications are sent to the terminal 104. Furthermore, although a single terminal 104 is shown, it will be appreciated that the communications network 100 may include any number of terminals 104, depending on the capacity of the network 100.

The terminal 104 or a specific user of the terminal 104 may be registered to receive various notification and information services provided by the state servers 102. The state servers 102 may provide state change notifications to all terminals 104 that are registered to receive notifications from the particular server 102. For example, the communications network 100 may include a voicemail server 106 that provides voicemail services to the terminal 104. A state change notification sent by the voicemail server 106 to the terminal 104 may inform the user that a voicemail message has been received and is ready to be retrieved by the user. Additional information may also be included in the state change notification, such as time that the message was received, the identity of the message sender, and the like.

The communications network 100 may also include a message server 108 that provides message services such as short message service (SMS) text messaging, multimedia message service (MMS) text messaging, email messages, and the like. A state change notification sent by the message server 108 to the terminal 104 may inform the user that a message has been received and is ready to be retrieved by the user. The state change notification sent by the message server may also include additional information, such as the identity of the sender, time that the message was sent, and the content of message, including text, pictures, audio files, video files, and the like.

The communications network 100 may also include one or more call servers, including a fixed call server 110 and a mobile call server 112, both of which provide telephone call related services to the user. The fixed call server 110 may provide telephone services to a telephone located at a fixed location, such as home phone or business phone. In embodiments, the fixed call server 110 may be a voice over Internet (VOIP) call server. The mobile call server 112 may provide telephone services to a mobile or cellular phone. The call servers 110 and 112 can provide state change notifications regarding status of a phone call that has been initiated or is in progress. For example, the call servers 110 and 112 may send a state change notification to the terminal 104 informing the user of an incoming telephone call for the terminal 104. Another state change notification may inform the user that another terminal to which an outgoing call has been directed is ringing or unavailable. To receive call status state notifications, the terminal 104 may be registered to receive state notifications regarding the phone state of another user in the network 100. This feature may be referred to as Busy Lamp Field (BLF) in reference to the lamp on the phone that may blink when one of the monitored extensions has an incoming call. Other information may also be included in the state change notification sent by the call servers 110 and 112 such as the identity of the caller, time of the call, call duration, and the like.

The communications network 100 may also include a presence server 114 that provides presence information to the user. The presence information may include an indication of the willingness or ability of a user to communicate with other users on the communications network 100. For example, a presence status may inform other users in the network 100 that the user's mobile phone is turned on. Presence information may also include information such as geographical location, whether a person is in attendance at an online Web meeting or teleconference, and the like.

The user or terminal 104 may be registered to receive presence information from certain other individuals coupled to the communications network 100. For example, the user may be subscribed to receive presence information for some or all of the contacts stored to the terminal's 104 contact list, such as for contacts corresponding to the phone numbers stored to the user's mobile phone. The terminal 104 may receive presence information through state change notifications sent by the presence server 114. Additionally, the terminal 104 may provide presence status updates to the presence server 114, which will then become available to other people that are registered to receive presence information from the user or terminal 104. The presence information may be updated automatically based on user activity conducted through the terminal 104. For example, presence information may be updated automatically when a user logs in to a teleconference or enters a chat room. The presence information may also be manually entered or selected by the user. For example, the user may select a mood indication, contact availability indication, or other status information pertaining to the user. Presence information sent to the presence server 104 by the terminal 104 may trigger the presence server 104 to send a state change notification to the other users or terminals 104 that have a presence registration for the user or terminal 104.

The communications network 100 may also include a user agent (UA) profile server 116 that can provide various profile updates to the terminal 104. For example, if the terminal 104 is a mobile phone, a profile update provided by the user agent profile server 118 may include new wallpaper images, ringtones, and the like. The profile update may also include changes to the menu options or layout of the mobile phone's user interface. A profile update delivered to the terminal 104 call also include settings related to phone Supplementary Services (SS) such as call forwarding rules to be applied locally by the terminal 104. The profile update may also include new applications or updates to the terminal's 104 firmware or software. A state change notification sent by the user agent profile server 116 to the terminal 104 may inform the user that a new profile is available for download from the user agent profile server 118.

The communications network 100 may also include a registration server 118 that manages basic information regarding each of the users or terminals 104 included in the communications network. The registration server 118 may be, for example, a Digital Subscriber Line (DSL) server. Further, the registration server 118 may be used to determine whether a terminal 104, such as a mobile phone, is turned on. The registration server 118 may store basic user account information including the user's name, phone number, terminal device type, mobile phone model, and the like. The registration server 118 may also identify notification services that the user is registered to receive from the other state servers 102.

In an embodiment, the communications network can include a State Composition and Notification server 120 configured to provide communications between the terminal 104 and the state servers 102. Rather than subscribing to each state server 102 individually, the terminal 104 subscribes to the State Composition and Notification server 120 and all state notifications are sent to the terminal 104 through the State Composition and Notification server 120. Thus, the State Composition and Notification server 120 serves as a unified communications portal that handles all communications between the terminal 104 and the state servers 102. In this way, the number of subscriptions and the related network traffic can be reduced. The State Composition and Notification server 120 and state servers 102 may be communicatively coupled through any type of network, including a Local Area Network (LAN), the Internet, and the like. Communications between the state servers 102 and the State Composition and Notification server 120 may be conducted according to any network protocol, including the Session Initiation Protocol (SIP), Web Services Notifications (WSN) protocol, among others. The communications protocol may vary from state server 102 to state server 102, according to the notification services provided.

Notifications sent to the terminal 104 may be encoded by the State Composition and Notification server 120 using a single unified communications protocol. In an embodiment, notifications sent from the State Composition and Notification server 120 to the terminal 104 are encoded using a Rich Presence Information Data format as a base format. The Rich Presence Information Data format is defined by the Internet Engineering Task Force (IETF), and described in Request for Comments (RFC) 3856, titled “A Presence Event Package for SIP”; RFC 4479, titled “A Data Model for Presence”; and RFC 4480, titled “RPID: Rich Presence Extensions to the PIDF,” among others. As defined by the Rich Presence Information Data format, a Rich Presence Information Data document can include the three elements, referred to as the “tuple,” “person,” and “device.” A tuple can include an identifier for a particular type of attribute and value for the attribute. The person identifies a particular user within the network 100. The device identifies a particular device or terminal 104 in the network.

New extensions may be added to the Rich Presence Information Data format to accommodate the various state notifications that may be sent by the various state servers 102. For example, new extensions may be added to provide new message indications, phone profile parameters, call status, call handling rules, and the like. The new extensions may take the form of additional Extensible Markup Language (XML) namespaces that are used to build the tuple, person, and device elements of the Rich Presence Information Data document. The new XML namespaces can be agreed upon between a vendor of the State Composition and Notification server 120 and vendors of the terminals 104. The interfaces and communications protocols between the state servers 102 and the State Composition and Notification server 120 may be kept unchanged, for example, using the existing communications protocols defined by the Internet Engineering Task Force without the new extensions.

In embodiments, the State Composition and Notification server 120 also employs a notification policy that determines the types of information and notifications that are published to the user or terminal 120. The notification policy may be managed by an administrator of the State Composition and Notification server 120 to add or remove notification services provided by the various state servers 102.

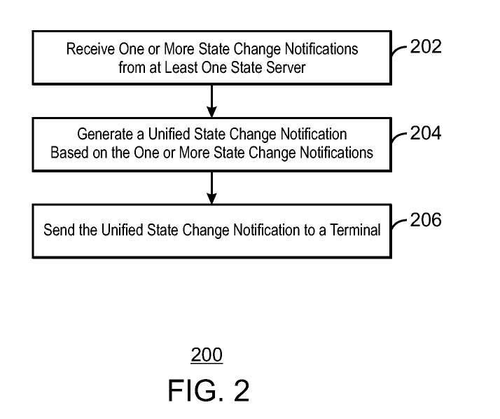

FIG. 2 is a block diagram of a method of processing state notification information, in accordance with embodiments of the present invention. The method is generally referred to by the reference number 200 and may be executed by the State Composition and Notification server 120 shown in FIG. 1. The method may begin at block 202, wherein the State Composition and Notification server 120 receives state change notifications from one or more of the state servers 102 as described in relation to FIG. 1. State change notifications may be received in more than one communications format depending on the specific state server 102 sending the notification. The state notifications can identify the specific user or terminal 120 that the state change applies to, as well as added information relevant to the particular type of state. For example, the state change notification may include call status information, presence information, profile update information, and the like.

At block 204, a unified state change notification may be generated based on the various notifications received from the state servers 102. For each notification received from one of the state servers 102, the State Composition and Notification server 120 may determine which users or terminals 104 are registered to receive the state change notification. The notifications directed to a particular user or terminal 104 may be encoded into a single unified notification by the State Composition and Notification server 120, for example, using the unified communications protocol described above in relation to FIG. 1. At block 206, the State Composition and Notification server 120 sends the unified state change notification to the terminal 104. The state change notification may be received by the terminal 104 and processed, for example, by activating one or more indicators such as, ring tones, textual messages or icons displayed on a display screen of the terminal 104, and the like.

The composition of a unified notification subscription that combines the notification services of several state servers 102 enables the implementation of additional state notification techniques. For example, a combined call state notification may be generated by the State Composition and Notification server 120 that combines state notifications from state servers 102 for fixed and mobile communications devices. In an embodiment, the state change notifications sent by the State Composition and Notification server 120 to the terminal 104 can notify the user of an incoming phone call on another phone associated with the same user. In other words, the state change notification may be received by the user's mobile phone and notify the user of an incoming call on the user's home or business phone. In an embodiment, a state change notification sent by the State Composition and Notification server 120 to the terminal 104 can notify the user that another person in the user's contact list is receiving an incoming call or has a call in progress. For example, an indicator associated with a contact stored to the terminal 104 may blink, showing a call status for that contact.

In an embodiment, a combined message state notification may be generated by the State Composition and Notification server 120 that combines state notifications from different message servers 102, such as the voicemail server 106 and the message server 108. For example, a state change notification sent by the State Composition and Notification server 120 to the terminal 104 can notify the user that the user has a message waiting, which may be a voicemail message, text message, email message, and the like. In other words, a common state change notification type may be used for each of the various types of messages which may be received by the terminal 104. A unified message-waiting indicator may be used at the terminal 104 to notify the user of the message-waiting state, without immediately specifying what type of message is waiting. The unified message-waiting indicator may be used instead of, or in addition to, separate message-waiting indicators for each type of message.

In an embodiment, the State Composition and Notification server 120 can send a notification to the terminal 104 that includes a new profile, for example, a new mobile phone profile. The profile may be downloaded and applied to the terminal 104 in a manner that is transparent to the user. Examples of phone profiles attributes are phone address, settings for call ringing, answering, forwarding, and the like. In embodiments, the State Composition and Notification server 120 may also enable new applications or firmware to be installed on the phone through the user agent profile server 116.

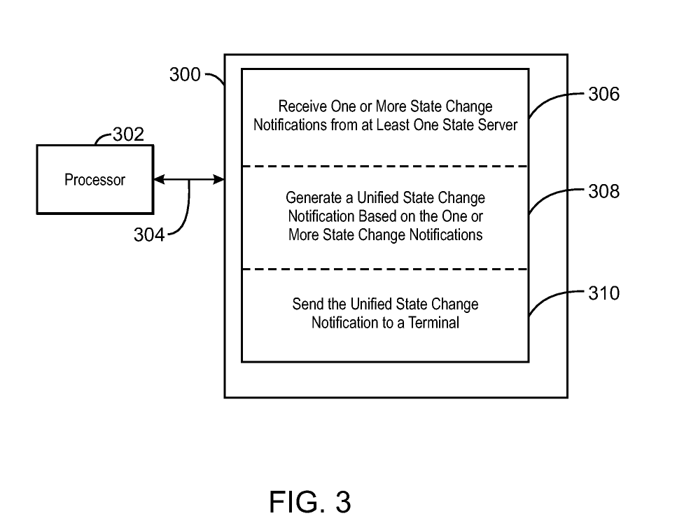

FIG. 3 is a is a block diagram showing a non-transitory, computer-readable medium that stores code configured to process state notification information, in accordance with an exemplary embodiment of the present invention. The non-transitory, computer-readable medium is referred to by the reference number 300. The non-transitory, computer-readable medium 300 can comprise RAM, a hard disk drive, an array of hard disk drives, an optical drive, an array of optical drives, a non-volatile memory, a universal serial bus (USB) drive, a digital versatile disk (DVD), a compact disk (CD), and the like. In exemplary embodiments, the non-transitory, computer-readable medium 300 is executed on a notification server such as the State Composition and Notification server 120 shown in FIG. 1. The non-transitory, computer-readable medium 300 may be accessed by a processor 302 over a communication path 304.

As shown in FIG. 3, the various exemplary components discussed herein can be stored on the non-transitory, computer-readable medium 300. A region 306 on the non-transitory, computer-readable medium 300 can include computer-readable instructions that, when executed by the processor 302, configure the processor 302 to receive one or more state change notifications from at least one state server such as the state servers 102 shown in FIG. 1. Another region 308 on the non-transitory, machine-readable medium 300 can include computer-readable instructions that, when executed by the processor 302, generate a unified state change notification based on the one or more state change notifications received from the at least one state server. A third region 310 on the non-transitory, machine-readable medium 300 can include computer-readable instructions that, when executed by the processor 302, send the unified state change notification to a terminal, such as the terminal 104 shown in FIG. 1. Although shown as contiguous blocks, the software components can be stored in any order or configuration. For example, if the non-transitory, machine-readable medium 600 is a hard drive, the software components can be stored in non-contiguous, or even overlapping, sectors.

What is claimed is:

1. A computer system for processing state change notifications, comprising:
at least one state server configured to generate a state change notification to be delivered to a terminal; and
a State Composition and Notification server operatively coupled to the at least one state server and configured to:
receive one or more state change notifications from the at least one state server;
generate a unified state change notification based on the one or more state change notifications received from the at least one state server; and
send the unified state change notification to the terminal.

2. The computer system of claim 1, wherein the unified state change notification is encoded using a data format based on an extended presence information data protocol.

3. The computer system of claim 1, wherein the at least one state server comprises a mobile phone call server and a fixed phone call server operatively coupled to the State Composition and Notification server.

4. The computer system of claim 1, wherein the at least one state server comprises a voicemail server and a text message server operatively coupled to the State Composition and Notification server.

5. The computer system of claim 1, wherein the at least one state server comprises a presence server operatively coupled to the State Composition and Notification server.

6. The computer system of claim 1, wherein the at least one state server comprises a user agent profile server configured to send a device profile update to the terminal.

7. The computer system of claim 1, wherein the terminal comprises a mobile phone.

8. A method of processing state change notifications, comprising:
electronically receiving one or more state change notifications from at least one state server over a communications network;
generating a unified state change notification based on the one or more state change notifications; and
sending the unified state change notification to a terminal.

9. The method of claim 8, comprising encoding the unified state change notification using a data format based on an extended presence information data protocol.

10. The method of claim 8, wherein the unified state change notification comprises a message-waiting notification that indicates that a user of the terminal has one of a voicemail message or a text message waiting to be retrieved, wherein a common message-waiting notification type is used for the voicemail messages and the text messages.

11. The method of claim 8, wherein the terminal comprises a first telephone and the unified state change notification comprises a notification that a second telephone is receiving an incoming phone call.

12. The method of claim 8, wherein the unified state change notification comprises a call status notification corresponding to a contact stored to a contact list of the terminal, wherein the call status notification indicates that the contact is receiving an incoming call.

13. The method of claim 8, wherein the unified state change notification notifies the user that an updated device profile is available for the terminal.

14. The method of claim 13, comprising sending the updated device profile to the terminal, wherein the terminal automatically updates the terminal with the new device profile.

15. A non-transitory, computer-readable medium, comprising code configured to direct a processor to:
receive one or more state change notifications from at least one state server;
generate a unified state change notification based on the one or more state change notifications; and
send the unified state change notification to a terminal.

16. The non-transitory, computer-readable medium of claim 15, comprising code configured to direct the processor to encode the unified state change notification using a data format based on an extended presence information data protocol.

17. The non-transitory, computer-readable medium of claim 15, wherein the unified state change notification comprises a message-waiting notification that indicates that a user of the terminal has one of a voicemail message or a text message waiting to be retrieved, wherein a common message-waiting notification type is used for the voicemail messages and the text messages.

18. The non-transitory, computer-readable medium of claim 15, wherein the terminal comprises a first telephone and the unified state change notification comprises a notification that a second telephone associated with the same user is receiving an incoming phone call.

19. The non-transitory, computer-readable medium of claim 15, wherein the unified state change notification comprises a call status notification corresponding to a contact stored to a contact list of the terminal, wherein the call status notification indicates that the contact is receiving an incoming call.

20. The non-transitory, computer-readable medium of claim 15, wherein the unified state change notification notifies the user that an updated device profile is available for the terminal.
